(19) United States
(12) Patent Application Publication
(10) Pub. No.: US 2009/0083945 A1
(43) Pub. Date: Apr. 2, 2009

(54) PAPER CLIP

(76) Inventor: Ming-Hsing Huang, Tai-Dong (TW)

Correspondence Address: PAI PATENT & TRADEMARK LAW FIRM, 1001 FOURTH AVENUE, SUITE 3200, SEATTLE, WA, 98154, US

(21) Appl. No.: 11/865,240

(22) Filed: Oct. 1, 2007

(51) Int. Cl. B42F 1/02

(52) U.S. Cl. 24/67.11

(57) ABSTRACT

A paper clip having a rectangular flat base frame defining a rectangular opening, a flat upright perpendicularly upwardly extending from one inner short side of the base frame, a flat clamping arm obliquely downwardly extending from the top of the flat upright toward the opposite inner short side of the base frame for holding down paper sheet members or the like on the base frame, and a flat endpiece obliquely extending from the free end of the flat clamping arm in a direction away from the base frame.

### BACKGROUND OF THE INVENTION

1. Field of the Invention

The present invention relates to a paper clip for securing a file or paper sheet members and more particularly to an inexpensive and durable paper clip.

2. Description of the Related Art

For securing sheet members (for example, paper) together without using a staple and allowing them to be freely and individually pulled away, a paper clip may be used. However, conventional paper clips are commonly made of a metal wire by bending. These paper clips can only secure a very small number of paper sheet members. When a number of paper sheet members are secured together with a paper clip, the clamping force of the paper clip will be weakened, and the paper sheet members may drop from the paper clip easily. Further, when removing individual paper sheet members from the paper clip, the ends of the metal wire of the paper clip may damage the paper sheet members accidentally.

### SUMMARY OF THE INVENTION

The present invention has been accomplished under the circumstances in view. It is the main object of the present invention to provide a paper clip, which is easy and inexpensive to manufacture and durable in use.

To achieve this and other objects of the present invention, the paper clip is made of a metal sheet member by stamping process; it comprises a rectangular flat base frame defining a rectangular opening, a flat upright perpendicularly upwardly extending from one inner short side of the base frame, a flat clamping arm obliquely downwardly extending from the top of the flat upright toward the opposite inner short side of the base frame for holding down paper sheet members or the like on the base frame, and a flat endpiece obliquely extending from the free end of the flat clamping arm in a direction away from the base frame.

### BRIEF DESCRIPTION OF THE DRAWINGS

FIG. 1 is a perspective view of a paper clip in accordance with a first embodiment of the present invention.

FIG. 2 is a schematic side view of the paper clip in accordance with the first embodiment of the present invention.

FIG. 3 is a schematic side view of a paper clip in accordance with a second embodiment of the present invention.

FIG. 4 is a schematic side view of a paper clip in accordance with a third embodiment of the present invention.

### DETAILED DESCRIPTION OF THE PREFERRED EMBODIMENTS

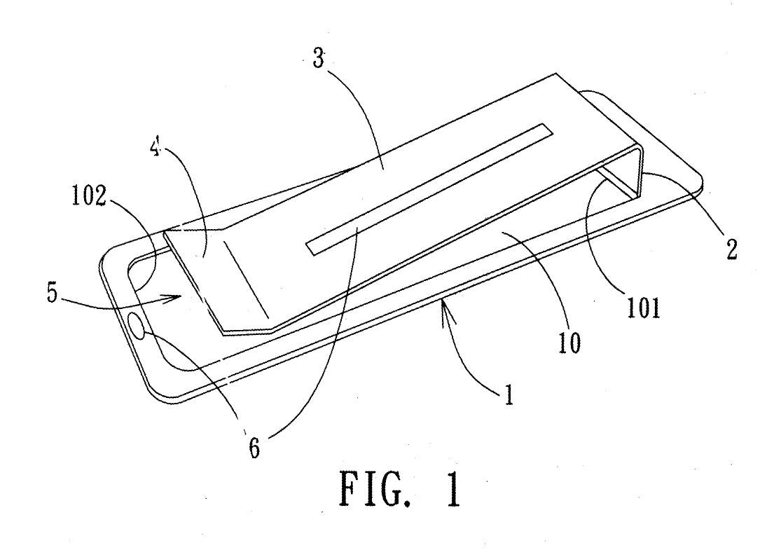

Referring to FIG. 1, a paper clip in accordance with the present invention is shown. The paper clip is made directly from a sheet metal (for example, steel sheet) by means of stamping process. The paper clip comprises a rectangular flat base frame 1 defining a rectangular opening 10 and two opposing inner short sides, namely, the first inner short side 101 and the second inner short side 102; a flat upright 2 perpendicularly upwardly extending from the first inner short side 101; a flat clamping arm 3 obliquely downwardly extending from the top of the flat upright 2 toward the second inner short side 102 and adapted to hold down paper sheet members or the like on the base frame 1; and a flat endpiece 4 obliquely extending from the free end of the flat clamping arm 3 in a direction away from the base frame 1 and defining with the second inner short side 102 of the base frame 1 a gap 5 through which a file, sheets of paper or the like can be inserted in between the flat clamping arm 3 and the base frame 1.

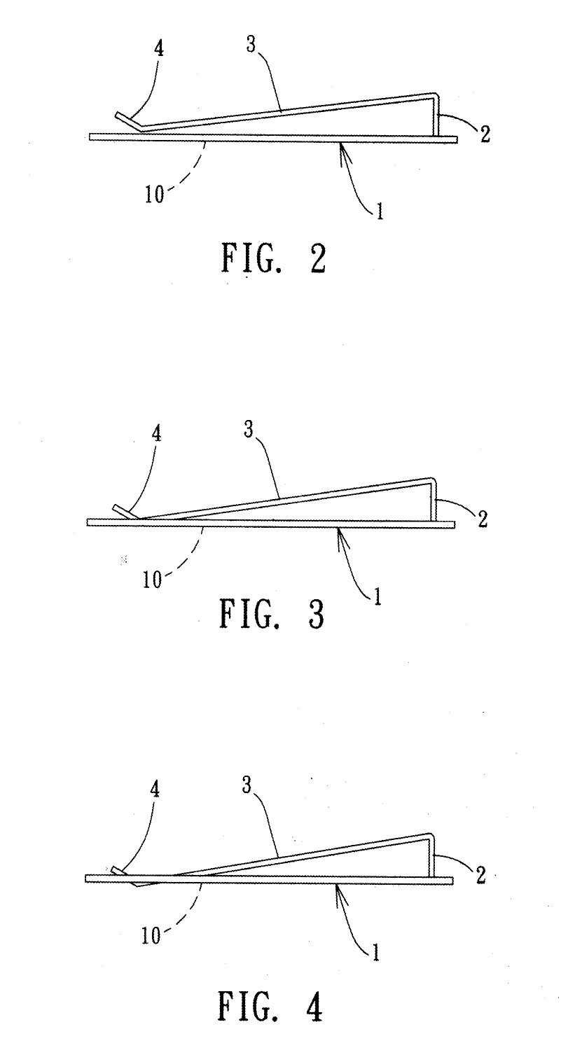

By controlling the location of the connection area between the flat clamping arm 3 and the flat endpiece 4 during sheet metal stamping process, the clamping force of the paper clip is relatively controlled. According to the embodiment shown in FIG. 2, the connection area between the flat clamping arm 3 and the flat endpiece 4 is spaced above the elevation of the rectangular opening 10 at a distance. According to the embodiment shown in FIG. 3, the connection area between the flat clamping arm 3 and the flat endpiece 4 is at the elevation of the rectangular opening 10. According to the embodiment shown in FIG. 4, the connection area between the flat clamping arm 3 and the flat endpiece 4 is below the elevation of the rectangular opening 10. Therefore, the paper clip according to the embodiment shown in FIG. 4 provides a relatively greater clamping force than that shown in FIG. 3 and that shown in FIG. 2, and the paper clip according to the embodiment shown in FIG. 3 provides a relatively greater clamping force than that shown in FIG. 2.

Because the paper clip is a stamped sheet metal (for example, steel sheet), its fabrication is simple and inexpensive. Further, because the paper clip does not have any sharp edge or pointed protrusion, it does not pierce paper during application. Further, because the flat clamping arm 3 obliquely downwardly extends from the top of the flat upright 2 toward the second inner short side 102 and the top of the flat upright 2 is spaced from the flat base frame 1 at a distance, the flat clamping arm 3 can hold down a number of paper sheet members on the flat base frame 1. Further, a design 6 (logo, trademark, trade name, pattern, etc.) can be printed or marked on the surface of the flat base frame 1 or the flat clamping arm 3 at the desired location for advertising or classification purpose.

Although particular embodiments of the invention have been described in detail for purposes of illustration, various modifications and enhancements may be made without departing from the spirit and scope of the invention. Accordingly, the invention is not to be limited except as by the appended claims.

The invention claimed is:

1. A paper clip comprising:
a rectangular flat base frame, said flat base frame defining a rectangular opening therein, a first inner short side at a first side of said rectangular opening, and a second inner short side at a second side of said rectangular opening opposite to said first inner short side;
an upright perpendicularly upwardly extending from said first inner short side; and
a clamping arm obliquely downwardly extending from a top side of said upright toward said second inner short side and adapted to hold down sheet members on said flat base frame.

2. The paper clip as claimed in claim 1, further comprising an endpiece obliquely extending from a free end of said clamping arm in a direction away from said flat base frame.

3. The paper clip as claimed in claim 2, wherein a connection area between said endpiece and said clamping arm is spaced above said flat base frame at a predetermined distance.

4. The paper clip as claimed in claim 2, wherein a connection area between said endpiece and said clamping arm is suspended within said rectangular opening.

5. The paper clip as claimed in claim 2, wherein a connection area between said endpiece and said clamping arm is spaced below said flat base frame at a predetermined distance.

6. The paper clip as claimed in claim 1, wherein said flat base frame is marked with a design.

7. The paper clip as claimed in claim 1, wherein said clamping arm is marked with a design.
